(19) United States
(12) Patent Application Publication
(10) Pub. No.: US 2004/0211314 A1
(43) Pub. Date: Oct. 28, 2004

(54) Method of manufacturing a piston, tooling for implementing the method, and a piston obtained thereby

(75) Inventor: Pierre Bousseau, Vanves (FR)

Correspondence Address: Dennis G. LaPointe, Mason Law, P.A., Suite 500, 17757 U.S. Hwy 19 North, Clearwater, FL, 33764, US

(73) Assignee: S.E.M.T. PIELSTICK

(21) Appl. No.: 10/824,026

(22) Filed: Apr. 14, 2004

(30) Foreign Application Priority Data
Apr. 23, 2003 (FR) 03 04985

(51) Int. Cl. F16J 1/14

(52) U.S. Cl. 92/187

(57) ABSTRACT

Obtaining a piston blank by forging a mass of metal. The metal mass is forged in a hollow anvil using a punch to chase said metal mass into an annular zone thereof while also forming a projection that projects from the center of a base, the punch including an open cavity suitable for giving rise to said projection. The projection is subsequently machined so as to include a bore suitable for receiving a hinge pin for a connecting rod.

The invention relates mainly to a method of manufacturing a piston or at least a portion thereof comprising the skirt and the means formed inside said skirt for making a connection with the connecting rod. The invention also relates to tooling for implementing the method, and to any piston obtained thereby. The invention is applicable in particular to manufacturing pistons of large dimensions for high power internal combustion engines.

### BACKGROUND OF THE INVENTION

In order to manufacture a piston for an engine, it is common practice to use aluminum, at least for constituting the skirt of the piston that houses the little end of the connecting rod and its hinge. Over the last few years, aluminum has been replaced progressively by a metal or an alloy of greater strength, in particular steel.

The piston often comprises two portions: a piston head forming the moving wall of the combustion chamber is held by tie rods to another part constituting the skirt of the piston, which other part has a large cavity housing a transverse pin mounted as a fork joint and the end of the connecting rod hinged to said pin. This part can be obtained by forging a mass of metal, e.g. steel, so as to constitute a blank of shape and dimensions that are as close as possible to those of the desired part. The part is obtained after a certain number of machining operations for finishing.

Difficulties are encountered associated with the size and the complexity of the cavity that needs to be formed. With a conventional configuration of piston skirt in which the little end of the connecting rod is hinged at the center of gravity, it is very difficult to displace enough metal to form such a cavity.

For a piston of large size, the problem is even greater. For example a forged skirt of large size leads to providing a blank, after forging, which requires so much machining for finishing that its final weight is reduced to about half.

It can thus be seen that such a method requires numerous and complicated machining operations and is consequently very expensive to implement.

The idea on which the invention is based consists in modifying the shape of the skirt that is conventionally used, so as to make the operation of forging easier, and so as to cause the resulting forging to be closer to the final shape, thereby reducing the amount of machining required for finishing.

A piston is known that comprises a central pillar in which a bore is formed for receiving a hinge pin or stub axle for a connecting rod, the end of said rod itself comprising two branches that form a fork. For example, French patent No. 2 135 429 describes a structure of that kind, but it relates to a piston of small size, having a diameter of about 60 millimeters (mm), being made of aluminum and entirely by machining.

By adopting that particular shape for the piston, it has been found that forging often becomes easier because there is no longer any need to hollow out a large cavity in the center of the part, the hollowed-out portions on the contrary being taken to the periphery, which makes it easier for metal to be displaced during forging. The blank that can be obtained is thus closer to the final configuration of the part, thereby correspondingly reducing the amount of machining required for finishing.

### OBJECTS AND SUMMARY OF THE INVENTION

More precisely, the invention relates to a method of fabricating a piston, the method comprising a step of forging a blank for at least a portion of said piston, the forging step being suitable for chasing an annular zone of a metal mass while forming a projection that projects from the center of a circular outline base, said projection being shaped and dimensioned so as to be pierced by a bore that is to receive a hinge pin for a connecting rod. The connecting rod has two branches forming a fork.

Advantageously, the projection of the blank may be shaped with two faces that are substantially plane, making an angle between them, so that the projection flares towards said base. This shape is in itself favorable for forging since it makes it easy to disengage the punch. It also makes it possible to give an advantageous configuration to the bore that is subsequently to be made through said projection. Under such conditions, the cylindrical area of the portion of the bore contained between the head of the piston and a longitudinal midplane of the bore perpendicular to the axis of said piston is greater than the area of the remainder of the bore, which constitutes a characteristic that is advantageous for accommodating the various stresses transmitted to the connecting-rod hinge pin mounted in the bore.

According to another characteristic, the forging also leads to two facing skirt portions being formed with substantially cylindrical outside surfaces, extending symetrically and facing each other on either side of the direction of the hinge pin (i.e. the hinge axis of the connecting rod). Between these two skirt portions, two large notches are formed extending generally transversely to said hinge-pin direction.

It can be seen that the recesses formed around the central projection make it easier for metal to rise in the die so as to create the two skirt portions and the projection itself. The method can be implemented in a press, providing it is powerful enough. Under such circumstances, the blank is obtained in two strokes. It is also possible to proceed in more conventional manner by hammering. In both cases the tooling is the same.

The invention also provides tooling for forging a blank for at least a portion of a piston, the tooling comprising a hollow anvil having a substantially cylindrical inside wall and a punch including an open cavity opening out into its end face, said cavity being of a shape and of dimensions that are suitable for defining a projection projecting from the center of a circular outline base formed at the end wall of said hollow anvil, said projection being for finishing by machining to include a bore suitable for receiving a hinge pin for a connecting rod, as defined above.

The invention also provides a piston including at least one portion forming a sliding skirt that is obtained by implementing the above-defined method and including a central pillar resulting from machining a projection obtained by forging, said pillar including a bore for receiving a connecting-rod hinge pin.

Naturally, the invention also applies to making a piston as a single piece, when no provision is made for making the piston head and its skirt separately.

### BRIEF DESCRIPTION OF THE DRAWINGS

The invention will be better understood and other advantages thereof will appear better on reading the following description given purely by way of example and made with reference to the accompanying drawings, in which:

FIG. 1 is a perspective view of tooling for forging a portion of an internal combustion engine piston, the die being shown partially in section;

FIG. 2 is a perspective view of the resulting blank shown in the forging direction;

FIG. 3 is a perspective view of the part shown in the same direction after the blank of FIG. 2 has been finished by machining;

FIG. 4 is a section on IV-IV of FIG. 3 shown in the opposite direction;

FIG. 5 is a section on V-V of FIG. 3, likewise in the opposite direction;

FIG. 6 is a section view of the complete piston, shown in the same section plane as FIG. 5, after the connecting rod has been assembled thereto; and

FIG. 7 shows a variant in which the connecting rod is guided laterally by the piston.

### MORE DETAILED DESCRIPTION

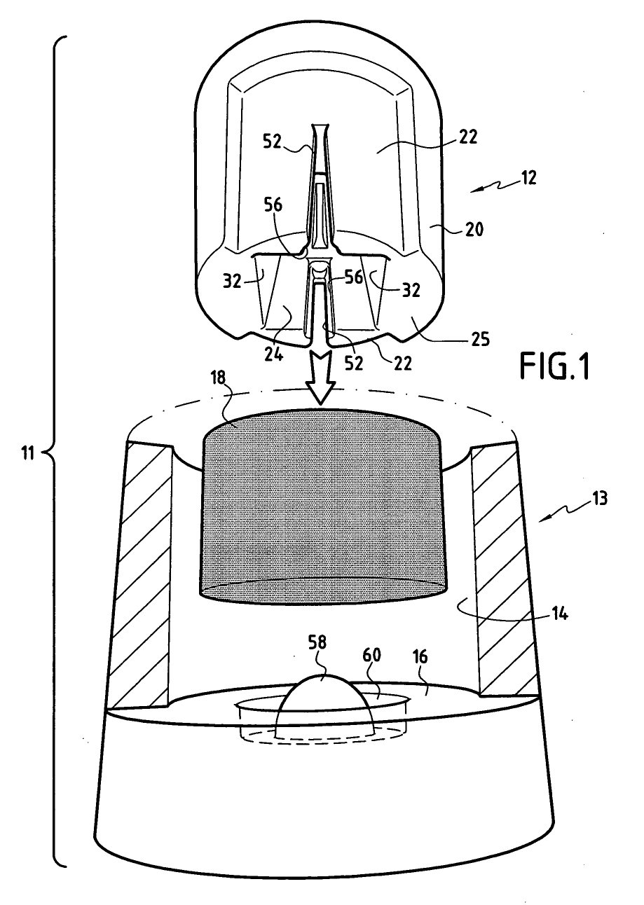

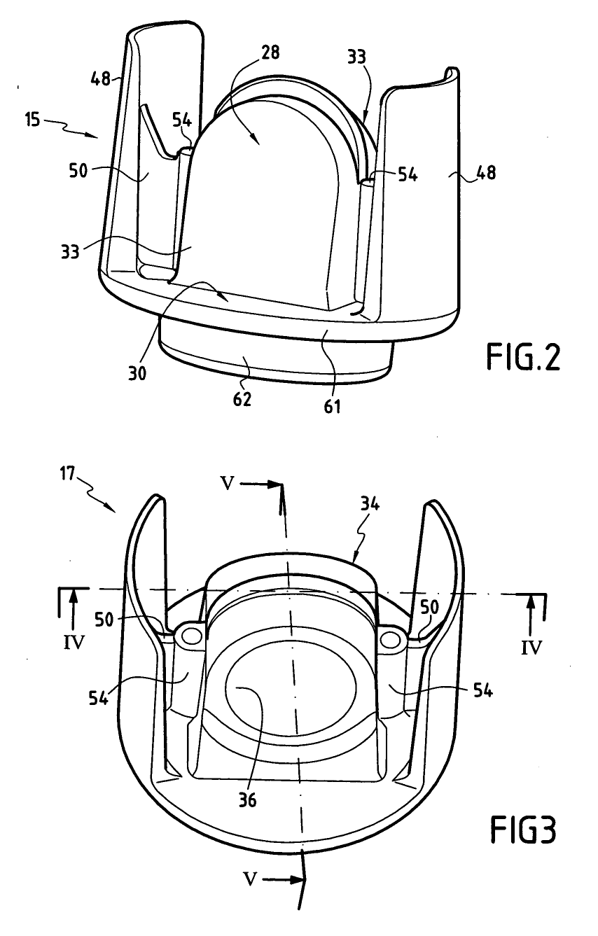

FIG. 1 shows tooling 11 for forging a blank of at least a portion of a piston, specifically the portion comprising the sliding skirt and the hinge means for the connecting rod. The blank 15 obtained at the end of forging is shown in FIG. 2. The corresponding part 17 after finishing has been performed by machining is shown in particular in FIG. 3.

The tooling comprises a punch 12 and a hollow anvil 13 comprising an internal side wall 14 that is substantially cylindrical and an end wall 16 of circular outline. The blank is shaped inside the hollow anvil by inserting a mass of metal 18 therein, in this case an approximately cylindrical mass, and by deforming said mass of metal using a punch 12 that is engaged in the anvil. As mentioned above, the anvil and the punch may be secured to respective panels of a press (not shown). Forging can also be obtained by hammering using a drop hammer carrying said punch. The same method may be applied using other metals, in particular metals that are more malleable. The invention is not limited to forging such a part out of steel. The method can turn out to be cost-effective even for obtaining parts made of light alloy. The outside surface 20 of the punch is generally cylindrical with the exception of two lateral recesses 22 which are described below. For forging purposes, this outside surface 20 tapers slightly as does the inside wall 14 of the anvil.

The punch includes an open cavity 24 that opens out into its end face 25 that engages in the anvil 13. This cavity is of shape and dimensions suitable for defining a projection 28 projecting from the center of a base 30 of circular outline which is formed at the bottom of the anvil between its end wall 16 and said end wall 25 of the punch. The cavity in the punch has two substantially plane faces 32 forming an angle between them so that the resulting projection 28 flares towards the base 30 formed at the bottom of the anvil. In other words, because of the shape of the cavity, the projection has two substantially plane faces 33 forming an angle between each other. As mentioned above, this shape of projection is advantageous both for forging and for reducing the amount of machining required to give the central pillar 34 its final shape.

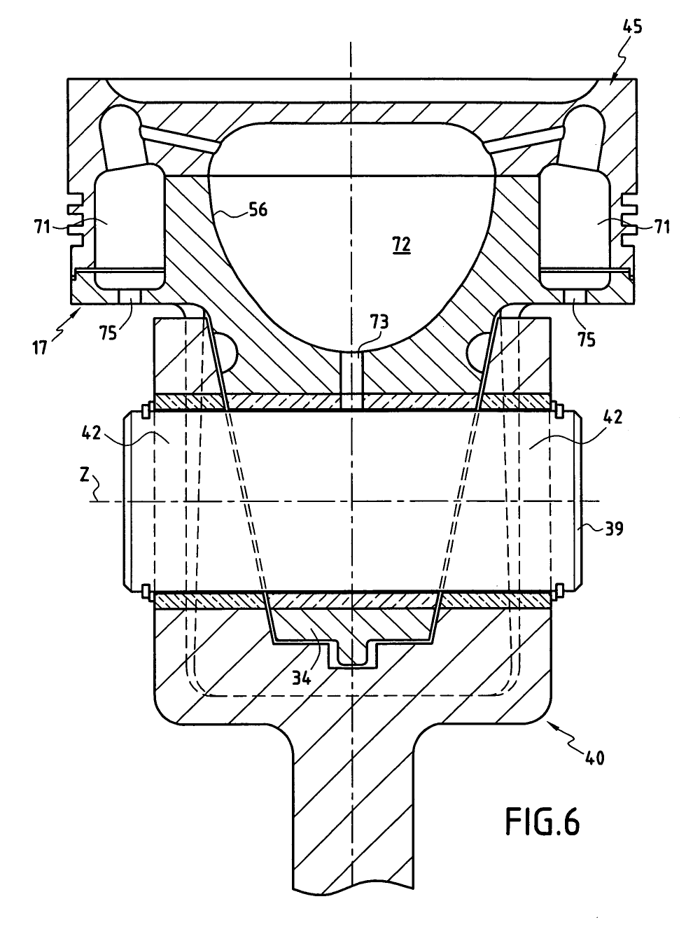

The projection is intended to be finished by machining so as to have a bore 36 (see FIG. 3) that is suitable for receiving a hinge pin 39 of a connecting rod. This connecting rod 40 as shown in particular in FIG. 6 is provided at one end with two branches 42 that form a fork, which branches are placed on either side of the central pillar 34 derived from said projection.

In other words, the method of fabricating the piston comprises a forging step that causes a blank 15 to be shaped (see FIG. 2) for at least a portion of said piston (in this case, specifically, the bottom portion that comprises the sliding skirt and the means for connecting to the connecting rod). Forging enables a recess to be dug out in an essentially central zone of a metal mass 18 so as to leave therein the projection 28 projecting from the center of the circular-outline base 30 that is formed at the bottom of the anvil 13. The blank is thus forged from its bottom end since the base 30 is the portion which is to receive a piston head 45. The piston head is made using a conventional process that does not form part of the invention. Nevertheless, it is possible to envisage forging a blank that corresponds to an entire piston.

In addition, the forging operation causes two skirt portions 48 to be formed having outside surfaces that are substantially cylindrical (in practice that are slightly tapered as is necessary for forging), located facing each other symmetrically on either side of the direction defined by the hinge pin. The term “hinge-pin direction” is used to designate the direction of the axis Z of the future bore that is to receive the hinge pin 39 for the connecting rod. In order to do this, it can be seen that the punch has two opposite lateral recesses 22 hollowed out in its outside surface and suitable for defining said two facing piston skirt portions.

Similarly, it is advantageous to allow a web 50 to remain between the projection and the inside wall of each skirt portion so as to make it easier to form these skirt portions by forging. For this purpose, a slot 52 extends between each recess 22 and said cavity 24 in the punch that is to form the projection.

In this example, a small column 54 is also allowed to remain between the projection 28 and the inside wall of each of the above-mentioned skirt portions. To do this, the inside wall of said cavity includes indentations 56 corresponding to said columns, which are thus formed in relief along the projection. As can be seen in the embodiment described, the webs 50 and the small columns 54 coincide. The columns are subsequently drilled to receive fixing tie bars enabling the piston head 45 to be secured to the part 17 that is derived from the forging.

Similarly, advantage is taken of the forging operation to form or at least begin a cavity 56 in the side of the base 30 opposite from the projection. More particularly, the end wall 16 of said hollow anvil includes a proeminence 58 suitable for forming said open cavity which will serve subsequently to constitute a portion of a cooling chamber. This proeminence projects from the end wall of a cylindrical recess 60 formed in the center of the end wall 16 of the anvil. Consequently, the blank that is obtained by forging includes a circular outline base presenting two portions of different thicknesses (FIG. 2), an annular peripheral portion 61 of relatively small thickness, and a central portion 62 of greater thickness housing the cavity 56.

As can be seen in FIG. 2, the end of the projection 28 is rounded. In other words, the end wall of the open cavity 24 in the punch is itself rounded.

At this stage in the description of the forging operation, it will be understood how much it is facilitated by the fact that the central portion of the metal mass 18 is moved little while forging is taking place. The metal is chased essentially into an annular zone of the metal mass all around the projection that is being formed, which leads essentially to the base 30 being formed and to the metal rising between the inside wall 14 of the die and the two lateral recesses 22 so as to give rise to the two facing skirt portions 48. In contrast, between these two skirt portions, the blank is completely open as can be seen clearly in FIG. 2 since no space is left between the outside surface of the punch (ignoring the recesses 22) and the inside surface of the die.

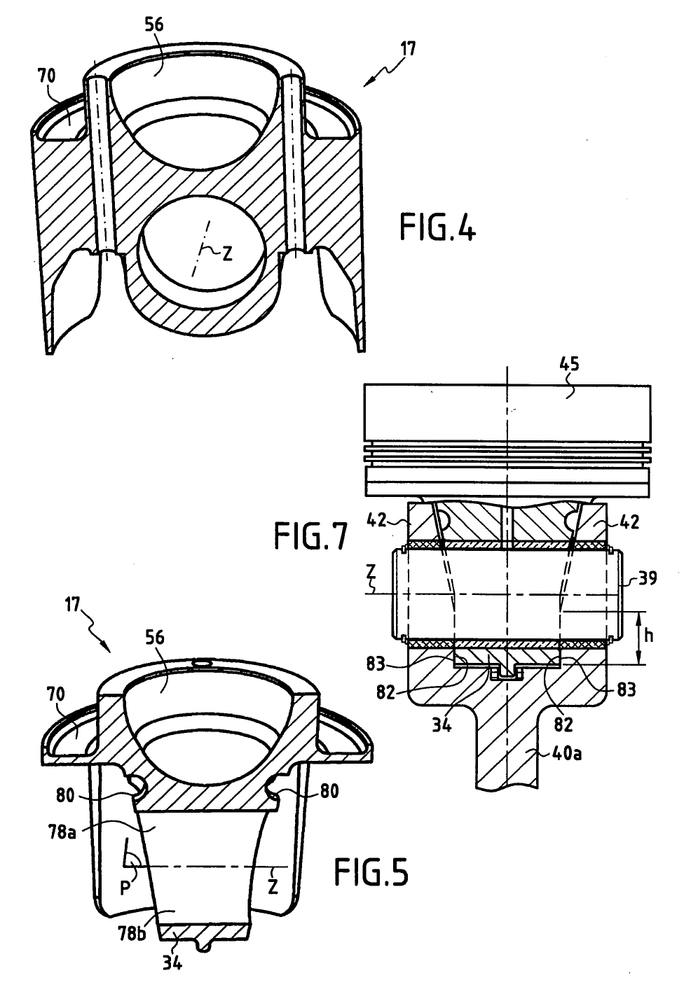

FIGS. 3 to 6 show the part 17 obtained after transforming the blank of FIG. 2 by machining operations. Few such operations are required. The outside surfaces of the two skirt portions 48 are finished so as to make them accurately cylindrical, the columns 54 are drilled, and the bore 36 is formed that is to receive the hinge pin 39 and its bearing 39a, as shown in FIG. 6. This enables the connecting rod 40 to be mounted, with the little end of the connecting rod presenting two fork-forming branches that pivot facing the two plane faces of the central pillar 34 derived from the projection. The piston head support face is also machined.

Furthermore, a groove 70 is formed in the finished portion of the base to co-operate with the piston head to define an annular cooling cavity 71 in communication with a central cooling chamber 72. The groove 70 may advantageously be obtained during forging. Oil enters via holes (not shown) in the connecting rod and the hinge pin in order to feed the cavity 72 via a hole 73, thereby lubricating the hinge at the end of the connecting rod on the way. The cavity 56 forms a portion of the chamber 52. Oil exits via the cavity 71 and holes 75 formed through the base. This disposition is conventional. The machined part that results from the blank is assembled to the piston head by means of two tie rods.

As can be seen in FIG. 5, because of the particular shape of the central pillar 34 obtained by machining the projection, the cylindrical area 78a of that portion of the bore which is contained between the piston head (not shown in FIG. 5) and a longitudinal midplane P of the bore perpendicular to the axis of the piston is greater than the cylindrical area 78b of the remainder of the bore. Consequently, other things remaining equal, the pillar is better able to contain the stresses coming from the hinge pin 39 of the connecting rod on each cycle of the piston. Cutouts 80 are advantageously formed in the central pillar beside the base so as to make the ends of the bore more flexible enabling it to comply better to deformations of the hinge pin.

In the example described with reference to FIGS. 1 to 6, the trapezoidal profile of the central pillar and of the facing faces of the end of the connecting rod require the connecting rod to be guided laterally by the crank shaft, which implies that guide cheeks need to be machined on the arms of the crank shaft. It may be preferred to use the arrangement shown in FIG. 7 which enables the connecting rod 40a to be guided by the piston itself. For this purpose, the terminal portion of the central pillar 34 is machined in a particular manner in that the inclined faces of said central pillar are rectified over a height h starting from the end of said central pillar so as to define two parallel surfaces 82 for guiding the connecting rod, the two branches thereof likewise being shaped with two corresponding parallel plane faces 83. Under such circumstances, it is not necessary to provide lateral guidance for the connecting rod by rectified cheeks of the arms on the crank shaft.

1. A method of fabricating a piston, the method comprising a step of forging a blank for at least a portion of said piston, the forging step being suitable for chasing an annular zone of a metal mass while forming a projection that projects from the center of a circular outline base, said projection being shaped and dimensioned so as to be pierced by a bore that is to receive a hinge pin for a connecting rod.

2. A method according to claim 1, wherein said forging also forms two skirt portions to be formed having substantially cylindrical outside surfaces, and disposed facing each other symmetrically on either side of a hinge-pin direction.

3. A method according to claim 1, wherein said projection is shaped with two substantially plane faces forming an angle between each other so that said projection flares towards said base.

4. A method according to claim 2, wherein a web is allowed to remain between said projection and the inside wall of each of the above-mentioned skirt portions.

5. A method according to claim 2, wherein a small column is allowed to remain between said projection and the inside wall of each of said skirt portions.

6. A method according to claim 1, wherein said forging operation is used to form a cavity in the side of said base that is opposite from said projection.

7. A method according to claim 1, wherein said blank is formed in a mass of steel.

8. Tooling for forging a blank for at least a portion of a piston, the tooling comprising a hollow anvil having a substantially cylindrical inside wall and a punch including an open cavity opening out into its end face, said cavity being of a shape and of dimensions that are suitable for defining a projection projecting from the center of a circular outline base formed at the end wall of said hollow anvil, said projection being for finishing by machining to include a bore suitable for receiving a hinge pin for a connecting rod.

9. Tooling according to claim 8, wherein said punch includes two opposite lateral recesses suitable for defining two facing piston skirt portions extending on either side of a hinge-pin direction.

10. Tooling according to claim 8, wherein a slot extends between each lateral recess and said cavity in order to define two webs each extending between a skirt portion and said projection.

11. Tooling according to claim 8, wherein the inside wall of said cavity includes indentations for columns.

12. Tooling according to claim 8, wherein said cavity includes two substantially plane faces forming an angle between each other so that said projection that results therefrom flares towards said base.

13. Tooling according to claim 8, wherein the end wall of said hollow anvil includes a preeminence suitable for forming an open cavity in the side of said base that is opposite from the projection of said blank.

14. A piston including at least one portion forming a sliding skirt obtained by a method of fabricating the piston, the method comprising:
a step of forging a blank for at least a portion of said piston, the forging step being suitable for chasing an annular zone of a metal mass while forming a projection that projects from the center of a circular outline base, said projection being shaped and dimensioned so as to be pierced by a bore that is to receive a hinge pin for a connecting rod and also including a central pillar obtained by machining a projection obtained by forging, said pillar including a bore suitable for receiving the hinge pin for the connecting rod.

15. A piston according to claim 14, wherein the cylindrical area of the portion of the bore contained between the head of the piston and a longitudinal midplane of the bore perpendicular to the axis of said piston is greater than the cylindrical area of the other portion of the bore.
